(19) United States
(12) Patent Application Publication
(10) Pub. No.: US 2007/0265950 A1
(43) Pub. Date: Nov. 15, 2007

(54) Share allocation systems and methods

(76) Inventor: Robert Reuss, Oakland, CA (US)

Correspondence Address: FISH & RICHARDSON P.C., PO BOX 1022, MINNEAPOLIS, MN, 55440-1022, US

(21) Appl. No.: 11/433,787

(22) Filed: May 11, 2006

(51) Int. Cl. G06Q 40/00

(52) U.S. Cl. 705/36 R

(57) ABSTRACT

Methods, apparatus, and computer program products for transactions are provided. In one implementation, a transaction system is provided. The transaction system includes a share allocation engine that allocates for each eligible transaction a portion of a share fee in the form of shares to one or more levels of shareholders. The transaction system also includes a dividend distribution engine that is operable to accumulate dividends on shares and a qualifying event detector. The qualifying event detector is operable to determine if a qualifying event has occurred and if a qualifying event has occurred, allow the redemption of shares in a subsequent transaction.

### TECHNICAL FIELD

This document generally relates to information systems.

### BACKGROUND

A conventional electronic commerce (e.g., internet) transaction is a discrete event that includes a purchaser, a purchased good or service or both, and a merchant. The purchaser can be an end user, reseller, or distributor. The good or service can be delivered using a conventional delivery mechanism, be electronically delivered, or picked up at a brick and mortar presence. The merchant can be a source of origin for the good or service, be a re-packager, a re-distributor, or other entity in a distribution chain of the good or service.

The transaction is conventionally deemed to be discrete in that once delivery and acceptance of the good or service has been performed, the transaction is complete. Thereafter, other transactions can be entered into between the purchaser and merchant, each representing a discrete event. While other more sophisticated purchase arrangements are possible, the vast majority of electronic commerce transactions follow this simple model.

Some merchants provide rewards that are delivered along with the purchased good or service. The reward may be of the form of a discount, additional product or services, or frequent user points or the like that can be redeemed for the same or other goods and services.

Of the many conventional transactions that are discrete events, the purchaser typically has no interest in the future success of the merchant. Further, the discrete nature of the transaction also provides no encouragement for the purchaser to contribute to the success of the merchant and provide referrals or other business generation support. To encourage such behavior, some merchants may offer rewards (discount or future services) to encourage a purchaser to assist in the future success of the merchant. For example, a cable television customer may be encouraged to make referrals of other customers to a cable television provider and can be rewarded with discounts on services, premium services or the like in return. Limits are conventionally placed on any such rewards to ensure adequate returns for the merchant (e.g., limiting the number of referrals one can make in a given time period, etc.). The rewards conventionally are selected by the merchant and represent little stake if at all in the future success of the selling enterprise.

What is desirable would be a more compelling reward program that creates customer loyalty to selling enterprises while providing significant benefits to the purchasers.

### SUMMARY

This document generally relates to methods, apparatus and computer program products for an electronic commerce transaction. More specifically, a customer loyalty system, method, and process are provided where customers receive share equity with purchases that enables the customers to benefit (e.g., financially or otherwise) as a result of future transactions of the same or similar good or service, or transactions by the merchant of other related or unrelated goods or services or in transactions executed on the exchange platform. In some implementations, redemption of the benefits requires additional purchases by the customers.

In one general aspect, a transaction system is provided. The transaction system includes a share allocation engine that allocates, for each eligible transaction, a portion of a share fee in the form of shares to one or more levels of shareholders. The transaction system also includes a dividend distribution engine that is operable to accumulate dividends on shares and a qualifying event detector. The qualifying event detector is operable to determine if a qualifying event has occurred and if a qualifying event has occurred, allow the redemption of shares in a subsequent transaction.

Implementations of the system can include one or more of the following features. The transaction system can further include a fee engine for determining a share fee to be collected for each transaction, the share fee being divided among shareholders by the dividend distribution engine. The transaction system can further include a redemption engine operable to determine if dividends can be redeemed and if so provide a benefit to a purchaser in a transaction based on the number of dividends redeemed. The transaction system can further include a membership engine operable to determine if a transaction is associated with a referral, and if so, providing a predetermined benefit to a sponsor of the referral. The benefit can be selected from the group including a percentage of a share fee associated with the transaction or an equivalent amount of shares.

In general, in one aspect, a transaction method is provided. An eligible transaction is identified. A share fee associated with the eligible transaction is determined. The share fee is distributed as a dividend among shareholders. A qualifying event is detected to allow for the vesting of dividends. Redemption of vested dividends in a subsequent transaction by a shareholder is allowed.

Implementations of the method can include one or more of the following features. The method can further include allocating shares to a purchaser associated with the eligible transaction. The method can further include allocating shares on two or more levels. Allocating shares can further include allocating the purchaser product shares, merchant shares, and shares in a transaction platform.

Redemption of shares can include redemption of individual share types based on a qualifying event of a predetermined type. Redemption of shares can include redemption of product shares after a subsequent purchase of a similar or identical product. Redemption of shares can include redemption of merchant shares after a subsequent purchase of any product from the merchant. Redemption of shares can also include redemption of platform shares after a subsequent purchase on the platform. The method can further include determining any sponsors of a purchaser associated with the transaction and provide a benefit to one or more of the sponsors. The method can further include distributing a portion of the share fee to the sponsors.

In general, in one aspect, a customer loyalty method is provided. An eligible transaction associated with a customer is identified. Shares are allocated to the customer. The shares are eligible for dividends based on future eligible transactions by the customer and others. Dividends are paid to the customer at each eligible future transaction. A qualifying event is required to redeem dividends. The redemption of dividends in a subsequent eligible transaction is allowed.

In general, in one aspect, a method for generating customer loyalty is provided. Equity is provided to a purchaser of an eligible transaction. A return on the equity is provided based on future sales. Future purchases are required to access the return.

Implementations of the method can include one or more of the following features. Providing equity can include providing equity in both a product or service purchased in the eligible transaction as well as equity in a merchant of the product or service. Providing equity can also include providing equity in both a product or service purchased in the eligible transaction as well as equity in a merchant of the product or service and a equity system. The eligible transaction can be an online retail exchange.

In general, in another aspect, an equity method is provided. Multi-level equity is provided to a purchaser in an eligible transaction. A return on the equity is provided at each equity level individually, based on future sales at each equity level. A return on equity is separately allowed at each level based on a qualifying action at a respective level

Advantages of the systems and techniques described herein may include any or all of the following. A customer equity system is provided that goes beyond an ephemeral and emotive system for generating customer loyalty to create a financially substantiated interest in products, merchants and the underlying exchange platform, an interest that drives future purchases and network marketing behavior. For consumers, the platform introduces new dimensions to purchase decision-making and shopping in general, as well as providing lucrative benefits.

The proposed customer equity system enables small and medium-sized merchants to participate in a high-stickiness loyalty system, the administration of which would not normally be cost-effective for a business of their size. In contrast to existing loyalty systems, the loyalty effects of which are somewhat difficult to prove and substantiate, the customer equity system proposed creates a real financial interest on the part of the customer, a meaningful, personal stake in the success of the platform, in individual merchants and specific products.

The proposed customer equity system offers a new kind of shopping experience for consumers, where the factors that traditionally drive purchasing decisions (price, quality, trust, brand, etc.) are expanded to include equity participation in the success of products and merchant businesses. The system is not just appealing to consumers on the level of saving money (which is what existing reward systems offer) but also in how it rewards choosing successful products and merchants on an on-going basis. That is, consumers who purchase successful products from successful merchants benefit more than consumers who do the opposite. This will serve to amplify, solidify, and reward an already existing but somewhat latent consumer preference to buy popular and successful goods, and deepen brand identification through equity participation. As customers develop equity in the platform, they will be drawn to return, to monitor their dividends, to build additional equity, and to refer friends and family.

The general and specific aspects may be implemented using a system, a method, or a computer program, or any combination of systems, methods, and computer programs. The details of one or more embodiments are set forth in the accompanying drawings and the description below.

### DESCRIPTION OF DRAWINGS

These and other aspects will now be described in detail with reference to the following drawings.

FIG. 1a shows a block diagram for a transaction system.

FIG. 1b shows a transaction process.

FIG. 2 shows a block diagram of the share allocation system of FIG. 1a.

FIG. 3 shows an exemplary share table.

Like reference symbols in the various drawings indicate like elements.

### DETAILED DESCRIPTION OF EXEMPLARY EMBODIMENTS

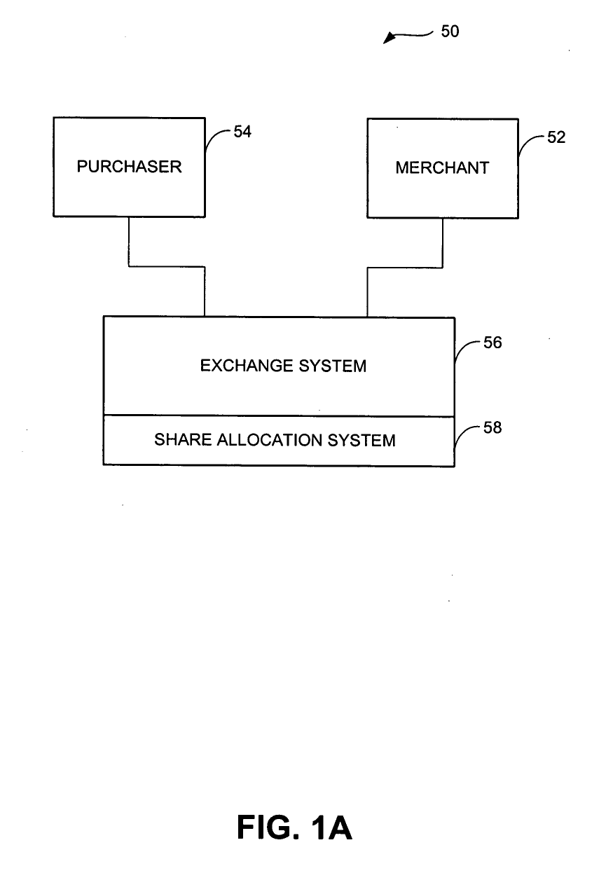

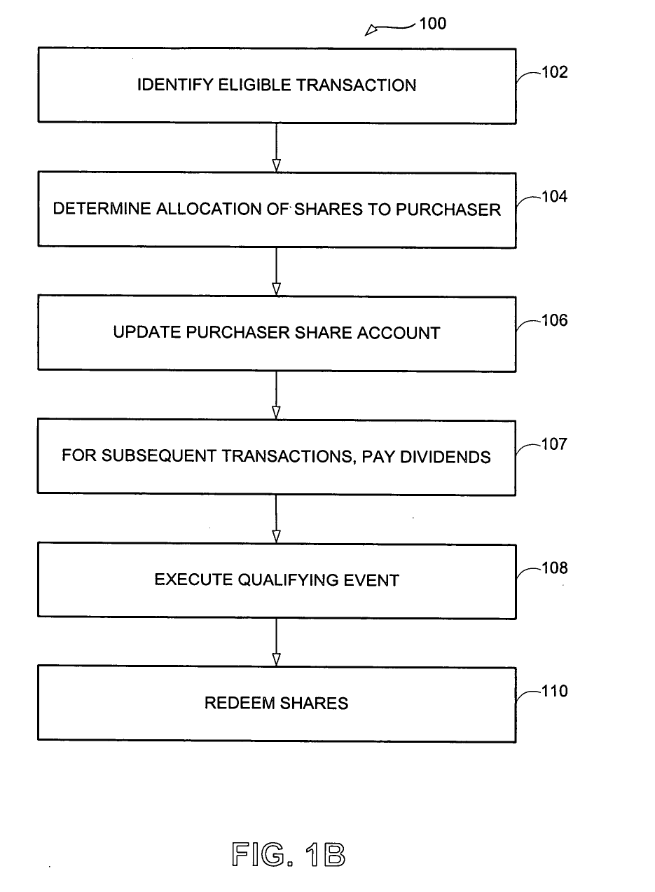

FIG. 1a is a block diagram for a transaction system 50. The transaction system 50 includes a merchant 52, a purchaser 54 and an exchange system 56 that includes a share allocation system 58. Various communication media can be coupled to the transaction system components. The transaction system 50 can be centralized or distributed, and one or more of the components can be co-located. Details of the merchant 52, purchaser 54, and exchange system 56 operation are discussed below in association with FIG. 1b. In one implementation, exchange system 50 allows merchants (e.g., small and medium-sized merchants/sellers/re-sellers) to lists goods for sale to potential purchasers (e.g., retail consumers) in an online, open, exchange context. Transaction system 50 can be of a form similar to conventional fixed-price merchant solutions offered by eBay™ and others, but includes a unique approach to generating customer loyalty. More specifically, exchange system 56 includes a share allocation system 58 for generating such loyalty.

Using the share allocation system 58, when a customer makes a purchase, a transaction fee (i.e., a share purchase fee (or hereinafter referred to as a share fee)), for example based on the purchase price, is collected (e.g., paid by the merchant). The share fee is used to acquire one or more types of shares (in one implementation, there are three types of shares: shares in the product, shares in the merchant, and shares in the exchange platform). Shareholders receive dividends for similar transactions (e.g., a dividend for each subsequent purchase made of 1) the same product, 2) of any product by the same merchant, and 3) all purchases on the exchange platform). The dividends are paid for from the share fee collected in the subsequent transactions.

FIG. 1b is a flow diagram for a transaction process 100 that can be implemented by the share allocation system 58 of FIG. 1a. The transaction may be a distributed transaction that can be implemented on one or several devices, including computing devices. Alternatively, the transaction can be implemented by non-computing means and only portions of the process steps are required to be executed by computing resources (e.g., calculation, accounting, and distribution of shares as will be discussed in further detail below). By way of example, the transaction process 100 will be described with reference to the transaction system 50 shown in FIG. 1a, however, the transaction system 50 shown in FIG. 1a is merely exemplary of a system that can be used to execute the process. Other system configurations are possible.

The transaction process 100 begins with an identification of a eligible transaction 102 (e.g., the purchase of a good or service by the purchaser 54 from the merchant 52 in coordination with the exchange system 56). The execution of the transaction includes the identification of the goods and/or services to be associated with the transaction, the settling of the terms, including consideration (e.g., money to be paid) for the goods and/or services and completion of the transaction (including acceptance and delivery of the purchased goods and/or services). One particular term in the transaction is the determination of a share fee. The share fee represents the portion of the transaction that is to be divided among current shareholders. Either the merchant or the purchaser can pay the share fee, though more typically, the merchant will effectively pay this fee by receiving a consideration sum that has been reduced by the amount of the share fee from the exchange system. Alternatively, the merchant may pay this fee separately, in advance or after completion of a single or group of transactions or at a predetermined time (e.g., quarterly). In one implementation, the share allocation system 58 makes the determination of the amount of the share fee to be associated with the transaction.

After execution, a determination is made as to the allocation of shares to be made to the purchaser 104 (e.g., by the share allocation system 58). In a simple example, the allocation of shares can require the calculation of a number of shares to allocate relative to a price paid for the goods or services. Further, shares may be allocated in different categories or different classes as will discussed in greater detail below.

An account associated with the purchaser is updated to reflect the allocation of shares 106. The account can be an individual account, business account, or a shared account (e.g., a group account, family account, etc.) This process can be repeated for some or all transactions processed by the exchange system 56.

Customers are “paid” dividends based on the allocation of shares 107. That is, transactions that result in a share fee recovery (including the one described in step 102) have a representative portion of the share fee credited in the form of a dividend to each shareholder account. The result is an accumulation of dividends based on the allocated shares. Dividends will be discussed in greater detail below.

Prior to redemption of the shares 110, a user of the system must exercise a qualifying event 108. Qualifying events and redemption are discussed in more detail below. In general, a qualifying event is an event that triggers the vesting of the shares in the purchaser. Vesting, for the purposes of this disclosure, refers to a particular state of shares, such characterized as being redeemable. Un-vested shares have not yet matured to the point of being able to be redeemed. Redemption in general refers to activities associated with using value accumulated in vested shares in a subsequent transaction. The value may be of the form of a discount, right to receive additional goods or service beyond what has been conventionally order, or other benefit (e.g., right to receive more shares, right to receive bonus shares, right to receive extra goods or services, right to a percentage discount, etc.).

Share Allocation System

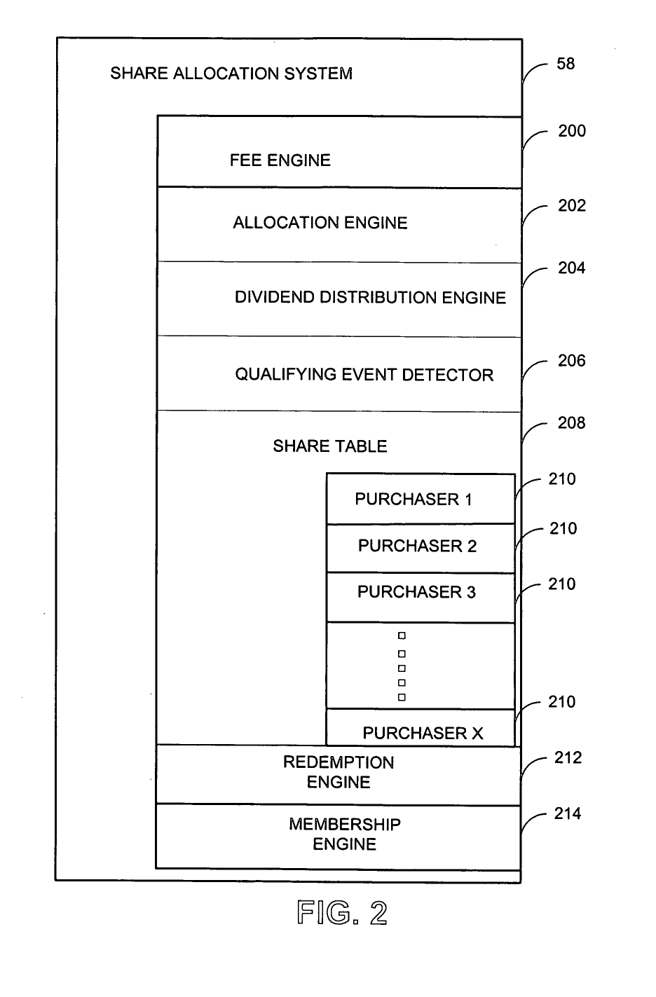

Share allocation system 58 (FIG. 1a) is shown in more detail in FIG. 2. In one implementation, share allocation system 58 includes a fee engine 200, an allocation engine 202, dividend distribution engine 204, qualifying event detector 206, share table 208, and a redemption engine 212, the details of which are described below. Optionally, a membership engine 214 can be included. Membership implementations are discussed in greater detail below.

Share Fee

In one implementation, the share allocation system is used in an online multi-merchant exchange context. In one implementation, participating sellers (e.g., merchants) pay the share fee (as a separate fee on top of the price extended to the customer). The share fee can be determined based on the purchase price, and in one implementation is in the range of 1-10% of the transaction price. In one implementation, the share fee is substantially 3%. Fee engine 200 determines the appropriate fee for a given transactions and ensures collection of the fee. If the merchant pays the share fee, the collection can be at the time of the transaction, when consideration is provided to the merchant, at a predetermined time (e.g., quarterly), or other time. Similarly, if the purchaser pays the share fee, the collection typically will be at the time of the transaction, though other times are possible depending on the nature of the transaction (e.g., at delivery).

In one implementation, the share fee may be determined as varying according to a given transaction. For example, for transactions less than a predetermined amount (e.g., less than $10), a first percentage can be used to calculate the share fee (e.g., 10%). For transactions above a second predetermined amount, a second different percentage can be used. For transactions in between, a third different percentage can be used to determine the share fee. Any number of levels can be included. Additionally, the same or different percentage amounts can be associated with transactions at each level.

In one implementation, the share fee may also be determined independently for one or more share types. For example, a first percentage rate can be associated with platform shares (e.g., 1%), a second percentage can be associated with merchant shares (e.g., 2%), and a third percentage can be associated with product shares (e.g., 5%). Further, different percentages can be attributed to different classes of shares of a given type (e.g., different percentages to “gold” platform shares, than “silver” platform shares).

In another implementation, share fee calculations can be based on a user's membership level or status. For example, based on numbers, value of transactions, membership classification or otherwise, users can classified as being associated with a predetermined level (i.e., membership level), and the level can be used to determine the share fee applicable. In other implementations, the share fee can be structured over time as opposed to being a specific single occurrence, for example, as might be desirable in a long term contract purchase.

Share Allocation

As described above, when a purchaser executes an eligible transaction, the purchaser is entitled to shares. Allocation engine 202 determines the number, type (e.g., level), and class of shares to distribute to the purchaser in a transaction.

More specifically, allocation engine 202 determines the number of shares (either whole or fractional as will be discussed in detail below), based on one or more criteria. Criteria can include the price of the transaction, the number of goods purchased, the number of transactions completed by the purchaser (e.g., a first time buyer may be incentivized with more shares than a previous purchaser), or other bases.

The allocation engine 202 also determines the type of shares that are to be allocated to the purchaser. Shares may be of different types. In one implementation, at least three different types of shares are possible: product, merchant, and exchange platform shares. In one implementation, the purchaser receives shares of one or more types in one or more classes. Share classes can be used to provide differentiation among similar shares for qualifying events (e.g., gold class shares produce dividends that can be redeemed forever, while silver class shares produce dividends that must be redeemed within a predetermined time period). In one particular application, the purchaser receives shares of all three types: product, merchant, and platform. In this sense, on the basis of the single share fee the customer is obtaining equity in plural levels of the transaction. In this implementation, the purchaser receives equity in: the individual product purchased; the merchant the product was purchased from; and the overall exchange platform. The equity gives the customer a “stake” in, for example, all three. By having a “stake”, the customer is now an agent in promoting the success of, for example, the product, the merchant, and the platform.

In some implementations, allocation engine 202 allocates less than all the number of available shares to a purchaser in a transaction (e.g., not all three levels of shares are allocated). For example, allocation engine 202 can be set to not allocate product shares for certain types of transactions; for example, in a context where one-of-a-kind goods were being sold or where services only are being provided, only merchant and platform shares might be issued. Further, the allocation engine 202 can be used in systems or transactions where the price of goods are not fixed, such as an online or traditional auction context, and in this case product shares may not be issued and only merchant and platform shares may be issued. In some implementations, the allocation engine 202 is implemented in a single merchant context, where no platform shares are issued and only merchant and product shares are issued. In one implementation, the allocation engine 202 can be implemented as a part of a credit card reward system, where purchases made with the card at qualifying merchants provide some or all levels (e.g. types) of shares.

Dividends

When subsequent transactions occur, the shareholders receive dividends. Dividend distribution engine 204 is responsible for distributing dividends among the shareholders.

Dividends are the product of the share fee divided equally among the appropriate shareholders at each level (i.e., in accordance differentiators among different types and classes of shares) and in accordance with any distribution allocation as may be in place among the different levels. For example, product shares may receive 40% of the share fee, while merchant and platform shares receive 30% of the share fee, respectively, in one implementation of a three-share type system. Other allocations among the different levels of shareholders can be provided. For example, each type and class of share can have a particular share fee percentage associated therewith. The share fee collected (e.g., the transaction times the appropriate percentage) can be allocated to the respective shares. Dividend distribution engine 204 can also redistribute dividends that have expired prior to vesting.

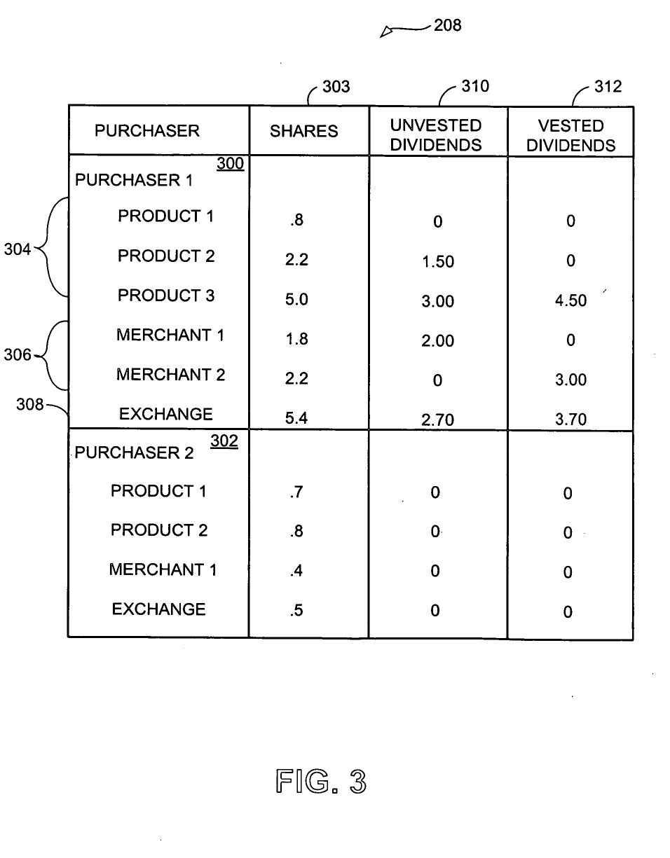

Associated with distribution engine 204 are one or more share tables 208. Share table 208 is used to store the share values, dividends, and status information associated with the purchasers 210. An example of entries stored in share table 208 is shown in FIG. 3. In the example shown, share table 208 includes entries for two purchasers 300 and 302, respectively. Purchaser 1 (300) includes share entries (shares 303) for a plurality of products 304, two merchants 306, and the exchange system 308. Further, purchaser 1 (300) includes dividend entries for each type of share. Dividends are classified as either unvested dividends 310 or vested dividends 312. In this example, fractional shares are also shown. Fractional shares, their effect on dividend payouts and the like are discussed in greater detail below. Other information can be stored in the share table 208, including status information associated with a purchaser (rating associated with user as to frequency of use of the system), share classes (e.g., premium or common), etc.

Qualifying Events

Shareholding customers may perceive an advantage, once they hold whole shares, to stay on the sidelines and no longer purchase on the platform and instead to simply reap rewards. To mitigate this, in one implementation, redemption of rewards is contingent on making an additional purchase; in other words, dividends are “locked up” or not vested until a qualifying event has occurred (e.g., another purchase is made to “free” them). In this example, dividends will accumulate on an on-going basis irrespective of additional spending, but customers can only access (i.e., redeem) those dividends when they make a subsequent purchase.

Qualifying event detector 206 detects qualifying events and converts shares from un-vested to vested for the purchaser. Qualifying event detector 206 can include qualification data defining the qualifying events associated with individual users, the system, specific merchants, and the like. In one implementation, a qualifying event is a purchase of another identical good or service from the same merchant. Alternatively, other qualifying events may trigger the ability to use (e.g., convert from un-vested to redeemable) some or all of the different levels of shares. For example, a purchaser may qualify for redemption of merchant shares by purchasing a different good or service from the same merchant. In one implementation, for merchant and product shares, customers must make a purchase at the specific merchant in order to access dividends received on the basis of shares in that merchant.

In systems that track shares at different levels (e.g., at the merchant level and the exchange level), individual qualifying events may allow for the redemption of shares at one or more levels. Accordingly, credit for a singular qualifying event may be applied to one or more levels in the system.

In one specific implementation, when transactions lead to dividends, the dividends are not immediately available to the shareholder. That is, in addition to requiring the shareholder to exercise, for example a qualifying purchase, the payment of dividends may be delayed a predetermined time period. For example, dividends may be paid periodically, rather than at the time of detection of the qualifying event.

As discussed above, in one implementation, a shareholder must make a qualifying purchase in order to gain access to a dividend. A qualifying purchase can be a purchase of the same type and scope of the associated share for which the dividend was issued. That is, a dividend on a platform share can require a new purchase on the platform, and a dividend on a merchant share can require a new purchase from the merchant. However, dividends on product shares may not require a qualifying purchase in order to gain access to the dividends. For example, dividends may be paid based on minimum activity levels not necessarily one for one transactions. Activity level can be measured based on a number of transactions, number of items purchased, amount of money spent, or other criteria.

Redemption

Shareholders may receive dividends as cash or apply them to subsequent purchases (or the current purchase if the dividends have been earned). In one implementation, once dividends have been received, subsequent dividends on the same shares require additional qualifying purchases to redeem those dividends.

In one implementation, shareholders have the option of applying existing dividends to a purchase (and thereby take advantage of the dividend immediately) or wait until the end of the quarter and receive their dividend as a cash payment. In other implementations, shareholders can also be given the option of directing their dividends to a charity of their choice on an annual basis and to form contribution teams with their friends and families to pool contributions. One or more of the exchange platform or the merchants may match some portion of the contributions in this scenario. A redemption engine 212 is used to clear dividends that have been redeemed from the share table 208.

Share Dilution

While each subsequent transaction on the system provides existing shareholders with new dividends, each subsequent transaction will also increase the number of shares outstanding (the float of shares) and in that way dilute the value of existing shares, because dividends are the product of the share fee divided among existing shareholders of the share type.

In one implementation, one means of mitigating the impact of share dilution is the use of fractional shares at one or more levels (e.g., at the merchant and platform level). For example, customers may receive a 1/10th platform share and a ⅕th merchant share for each purchase, and dividends may only be paid for whole shares. This will create a vesting cliff, where a customer must demonstrate loyalty through repeat purchases or reaching a certain dollar amount in purchases in order to begin fully participating in the redemption (i.e., reward) system. Additionally, the rewards of loyal customers are subsidized and amplified by the fees paid by less loyal customers and by customers who are not yet fully vested as whole shareholders.

In another implementation, share fractions are aligned/related to dollar amounts (e.g., a customer would need to purchase a predetermined dollar amount (e.g., $500) worth of merchandise to reach the whole share level to begin to receive dividends). In this implementation, the size of the fractional share allocated to the purchaser is determined based on the purchase price and some predetermined fixed whole share level dollar amount. Other ways of allocating the fractional amount are possible, including allocating additional fractions or higher amounts for more loyal/frequent purchasers. Allocation engine 202 of FIG. 2 can set the fractional amounts to be associated with a given transaction.

In one implementation, the smallest fractional share (and hence the biggest vesting cliff) is attributed to the platform (e.g., exchange) level. In that way, share dilution will be most rapid at this level, and next at the next lower level in the hierarchy (e.g., the merchant level). In one implementation, fractional shares are not used at the product level at all because it may not make sense for customers to make repeat purchases of some products.

Tuning the System

In one implementation the share allocation system can be tuned to make adjustments to customize the reward process. Customizations can be included to: 1) mitigate share dilution; 2) ensure a particular reward range for a certain level of spending; 3) ensure higher rewards for higher value purchases or ongoing purchasing; 4) create the possibility of disproportionately high rewards for certain kinds of behavior, such as first buyer, first five buyers, multiple purchases of same product, etc. (a key example of this type of high reward would be having the entire cost of a product covered by dividends); 5) directly reward network/viral marketing; 6) disrupt inappropriate or unfair ways customers could “game” the system; and 7) encourage consumers to increase consumer involvement or enthusiasm.

In some implementations, one or more of the following adjustments to the share allocation system can be made to realize one or more of the identified customizations: 1) create a specific proportional allocation of share fees between platform, merchant and product shares (e.g., the platform share can get the largest percentage, the merchant second and the product third); 2) assign fractional shares and set their size to create a vesting cliff at one or more of the share levels (e.g., at the merchant and platform level); 3) base the allocation of shares, and more specifically, the number of shares rewarded on not only on each product-based transaction but also on the price of the product (e.g., it may be unreasonable to provide the same share for a $10 product as a $100 product; 4) provide a greater share reward to early purchasers of a product; 5) associate an expiration date with shares in order to mitigate dilution; 6) provide for two or more classes or tiers of shares (e.g., gold and silver) at a given level (e.g., at the platform level) with different vesting cliffs (e.g., 1/10th, 1/100th, 1/1000th share per transaction); and 7) provide an option to convert one or more share types (e.g., platform shares) into real business equity (e.g., actual shares of corporate stock) in the exchange.

In one implementation, while some mixture of these tuning mechanisms can be used, the system may limit the tuning so as to sufficiently keep the system simple as to be both easily understood and transparent to consumers. That is, the typical customer should be able to understand the basis for determining the allocation of shares they receive for a purchase, as well as the basis of the dividends they receive, and the steps required for redemption.

In some implementations, the process associated with an initial transaction includes the following steps: purchasing a good or service; determining a share fee; allocating the share fee in appropriate amounts to one or more types of shares; and updating the allocation of shares. In some implementations, a process for dividend handling includes: accumulating dividends; determining that vesting events have occurred; and distributing the dividends to record shareholders. In some implementations, processing each transaction includes: determining if a qualifying event has occurred including the type of event, whether the event results in a whole share value, whether sufficient time, transactions, or fees have been received; flagging or otherwise marking shares for vesting purposes; and communicating to the shareholder the vesting status of the shares. In some implementations, the redemption process includes: identifying a qualifying transaction; identifying vested shares; receive qualifying dividends to reduce or otherwise diminish the transaction cost to the purchaser; and update the dividend allocation.

In some implementations, a settlement period may be provided between the allocation of shares and the eligibility to receive dividends. The settlement period can be used to correct for situations where goods are purchased, then subsequently returned (e.g., the staggering allows for the system not to be tricked into giving away dividends too quickly while transactions are still pending (e.g., are still able to be cancelled)). The settlement time can be varied with the exchange policies associated with particular platforms, merchants or goods. In some implementations, no settlement period is required (e.g., services or “as is” or “final” sales).

In one implementation the share allocation system described above can be used in association with a credit card, debit card, or other financial instrument transactions. For example, in a credit card implementation, merchants (or consumers) can register credit card accounts with the proposed equity system. Registered cards would be eligible to receive shares and have shares fees either added to transactions or otherwise covered (e.g., covered by the credit card supplier as part of a service for owning/using the card). Dividends can be credited to the card to allow for future transactions of as a credit against outstanding debits. The equity system including share allocation, share status, dividend eligibility, dividend payment, and the like can be managed using, for example, a Web interface.

Membership System

The share allocation system described above can be accessed through a membership system. The membership system can be separate or integrated with the share allocation system. Qualification for, authentication of, and other membership handling activities can be performed by a membership service, system, or engine (e.g., membership engine 214). In one implementation, membership is on a referral only basis. That is, in this implementation, members are added by invitation only. Referrals are discussed in greater detail below. Membership can be required to receive shares and dividends in the system. Membership can include a combination of rights and obligations. Rights can include access to the system, accrual of benefits (e.g., accrual of shares and dividends), and the like. Obligations can include initial or regular dues, performance obligations (e.g., executing a certain number of transactions per cycle), and the like. In one implementation, the initial membership fee can be fixed (e.g., $10). The membership system can include a membership engine (e.g., membership engine 214) that qualifies new members, handles referrals, makes invitations, monitors member activity, revokes memberships, interfaces with the share allocation system, and the like. Interfacing with the share allocation system can include, for a given transaction: 1) determining if a transaction involves a member; 2) determining if the member is a referral; 3) determining a status of a member and/or a sponsor; and 4) allocating a benefit to a sponsor. Sponsors and referrals are discussed in greater detail below.

Referrals and Sponsors

Referrals can be used to encourage further membership and result in greater dividends. A sponsor refers to a member in the equity system who provides an invitation or otherwise identifies a candidate member. Once invited, the candidate member is referred to herein as a “referral.” In one implementation, each member is allocated a predetermined number of invitations (e.g., 5) that can be extended, so as to limit the number of referrals (e.g., to only friends and family) associated with a given member. As will be discussed below, the sponsor in a membership based system can have certain additional rights (e.g., to receive benefits) and obligations based on the activities of referrals.

Sponsor rights can include the following: 1) right to a portion of the referrals membership fees or dues; 2) right to a percentage of the share fees paid by the referrals; 3) right to shares based on activities of the referrals. The sponsor may be restricted in accessing benefits accrued. For example, the sponsor may be required to make qualifying additional purchases (e.g., from the same merchant) to redeem shares earned from a referral. Further, the shares themselves have restrictions including settling periods, vesting and the like prior to the awarding of dividends. Rights can be limited. For example, rights for receiving shares, dividends or other benefits based on referral activity can be limited in duration or scope. For example, a sponsor may receive a benefit from only a first predetermined number of transactions associated with a given referral. In one implementation, a sponsor may only have a predetermined number of active referrals. As used in this context, an active referral is one that is producing direct (e.g., not indirect benefits that are generally accrued due to referral activities that benefit all shareholders of a class) benefits for a given sponsor.

Sponsor obligations can include the following: 1) obligation to vouch for referrals, and hence may forfeit benefits if the referral either does not live up to his own obligations or otherwise acts badly; and 2) obligation to limit referrals to a specific number. For example, the issuance of a invitation to a candidate member is, in one implementation, an express vouching for the candidate member. If the referral fails to meet obligations of the system, the sponsor may relinquish shares, dividends, fees or membership as appropriate.

In one implementation, sponsors and memberships can be extended to merchants. That is, merchants can be invited to become members in the equity system by either other merchants or consumers. Rights (e.g., benefits) and obligations can be accrued in both the sponsors (of the merchant) and the new member. More specifically, just as described above, the sponsor of a merchant may have rights and obligations relating to the sponsored merchant. In one implementation, merchants can be sponsors of consumers. For example, a merchant can be a sponsor of a consumer and receive as a benefit a percentage of the members (the referrals) membership dues. Other types of rights and obligations for merchant members are possible. For example, merchant members can have rights as follows: 1) right to a portion of a membership fee of referred members; 2) right to a percentage of a share fee as a dividend including, for example, share fees associated with transactions with other merchants in the system (i.e., dividend from referral member transactions); 3) right to a percentage of the share fees as shares in a higher level in the hierarchy (e.g., receive shares in the platform that the merchant can accrue dividends on based on referral member transactions).

The methods described herein may be implemented in digital electronic circuitry, or in computer hardware, firmware, software, or in combinations of them. Apparatus may be implemented in a computer program product tangibly embodied in an information carrier, e.g., in a machine-readable storage device or in a propagated signal, for execution by a programmable processor; and actions of the method may be performed by a programmable processor executing a program of instructions to perform functions of the invention by operating on input data and generating output. Implementations may include one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language, including compiled or interpreted languages, and it may be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer may include a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, a computing device may include a display device such as a CRT (cathode ray tube) or LCD (liquid crystal display) monitor for displaying information to the user and a keyboard and a pointing device such as a mouse or a trackball by which the user may provide input to the computer.

Apparatus and methods disclosed herein may be implemented in a computing system that includes a back-end component, such as a data server; or that includes a middleware component, such as an application server or an Internet server; or that includes a front-end component, such as a client computer having a graphical user interface or an Internet browser, or any combination of them. The components of the system may be connected by any form or medium of digital data communication such as a communication network. Examples of communication networks include, e.g., a LAN, a WAN, and the computers and networks forming the Internet.

The computing system may include clients and servers. A client and server are generally remote from each other and typically interact through a network, such as the described one. The relationship of client and server may arise by virtue of computer programs running on the respective computers and having a client-server relationship to each other.

The computing system may be embodied in a portable device, such as a handheld electronic device (e.g., a personal digital assistant) or a mobile communication device (e.g., a cell phone or smartphone). In some implementations, non-volatile memory, such as, for example, flash memory, EEPROM or removable storage media may provide mass storage to the computing system. In some implementations, a mass storage device may be provided outside of the computing system, and data in the mass storage device may be accessible to the computing system via an interface, such as a wireless interface, a wired interface, or a card or device reader interface.

A number of implementations have been described. Nevertheless, it will be understood that various modifications may be made without departing from the spirit and scope of this disclosure. For example, consumers that acquire equity of the various share types can be individual consumers, merchants, or other class members. Members who are eligible to receive cash dividends may instead be rewarded with discounts on membership fees (up to and including a 100% discount) or other transaction costs or fees (e.g., a discount on a future transaction). In addition to the referral share benefits describe above, in one implementation, a sponsor can be rewarded benefits for both activity of sponsored members and the referrals of the sponsored members. Accordingly, other implementations are within the scope of the following claims.

What is claimed is:

1. A transaction system comprising:
a share allocation engine that allocates for each eligible transaction a portion of a share fee in the form of shares to one or more levels of shareholders;
a dividend distribution engine that is operable to accumulate dividends on shares; and
a qualifying event detector operable to determine if a qualifying event has occurred, and if so, allow the redemption of shares in a subsequent transaction.

2. The transaction system of claim 1, further comprising a fee engine for determining a share fee to be collected for each transaction, the share fee being divided among shareholders by the dividend distribution engine.

3. The transaction system of claim 1, further comprising a redemption engine operable to determine if dividends can be redeemed and if so provide a benefit to a purchaser in a transaction based on the number of dividends redeemed.

4. The transaction system of claim 1, further comprising a membership engine operable to determine if a transaction is associated with a referral, and if so, providing a predetermined benefit to a sponsor of the referral.

5. The transaction system of claim 4, where the benefit is selected from the group consisting of a percentage of a share fee associated with the transaction or an equivalent amount of shares.

6. A transaction method, comprising:
identifying an eligible transaction;
determining a share fee associated with the eligible transaction;
distributing the share fee as a dividend among shareholders;
detecting a qualifying event to allow for the vesting of dividends; and
allowing a redemption of vested dividends in a subsequent transaction by a shareholder.

7. The transaction method of claim 6, further comprising allocating shares to a purchaser associated with the eligible transaction.

8. The transaction method of claim 7, further comprising allocating shares on two or more levels.

9. The transaction method of claim 8, where allocating shares further comprises allocating the purchaser product shares, merchant shares and shares in a transaction platform.

10. The transaction method of claim 9, where redemption of shares includes redemption of individual share types based on a qualifying event of a predetermined type.

11. The transaction method of claim 9, where redemption of shares includes redemption of product shares after a subsequent purchase of a similar or identical product.

12. The transaction method of claim 9, where redemption of shares includes redemption of merchant shares after a subsequent purchase of any product from the merchant.

13. The transaction method of claim 9, where redemption of shares includes redemption of platform shares after a subsequent purchase on the platform.

14. The transaction method of claim 6, further comprising determining any sponsors of a purchaser associated with the transaction and provide a benefit to one or more of the sponsors.

15. The transaction method of claim 14, further comprising distributing a portion of the share fee to the sponsors.

16. A customer loyalty method, comprising:
identifying an eligible transaction associated with a customer;
allocating shares to the customer, the shares eligible for dividends based on future eligible transactions by the customer and others;
paying dividends to the customer at each eligible future transaction;
requiring a qualifying event to redeem dividends; and
allowing the redemption of dividends in a subsequent eligible transaction.

17. A method for generating customer loyalty, comprising:
providing equity to a purchaser of an eligible transaction;
providing a return on the equity based on future sales; and
requiring future purchases to access the return.

18. The method of claim 17, where providing equity includes providing equity in both a product or service purchased in the eligible transaction as well as equity in a merchant of the product or service.

19. The method of claim 17, where providing equity includes providing equity in both a product or service purchased in the eligible transaction as well as equity in a merchant of the product or service and a equity system.

20. The method of claim 17, where the eligible transaction is an online retail exchange.

21. An equity method, comprising:
providing multi-level equity to a purchaser in an eligible transaction;
providing a return on the equity at each equity level individually, based on future sales at each equity level; and
separately allow for a return on equity at each level based on a qualifying action at a respective level.
